(19) United States
(12) Patent Application Publication
(10) Pub. No.: US 2013/0296750 A1
(43) Pub. Date: Nov. 7, 2013

(54) INSTRUMENTS FOR TREATMENT OF SOFT TISSUE

(71) Applicants: Mark W. Pursel, Grantville, PA (US); Francis X. Osborne, Conshohocken, PA (US)

(72) Inventors: Mark W. Pursel, Grantville, PA (US); Francis X. Osborne, Conshohocken, PA (US)

(21) Appl. No.: 13/385,610

(22) Filed: Apr. 21, 2011

(51) Int. Cl. A61H 99/00

(52) U.S. Cl. CPC A61H 99/00
USPC 601/137

(57) ABSTRACT

The present application teaches various tools for the treatment of soft tissue, the tools having one or more skin-contacting portion(s). In some embodiments, the tools have a textured surface comprising cross-hatch members that help a user improve their grip on the tools. In other embodiments, the tools have handles for this purpose.

### FIELD OF INVENTION

The present invention relates to the field of medical tools and devices, more particularly to tools for the treatment of soft tissue.

### BACKGROUND

The treatment of soft tissue—e.g. muscle, ligament, tendon, or combinations thereof—using tools is known in the art. For example, U.S. Pat. No. 5,231,977, issued Aug. 3, 1993, U.S. Pat. No. 5,366,437, issued Nov. 22, 1994, U.S. Pat. No. 5,441,478, issued Aug. 15, 1995, U.S. Pat. No. 5,707,346, issued Jan. 13, 1998, and U.S. Pat. No. 6,126,620, issued Oct. 3, 2000, all of which are incorporated herein by reference as if fully set forth, disclose tools and methods for performing soft tissue massage or therapy using physical tools.

Since soft tissue massage and therapy is often performed using a lubricant applied to the skin adjacent to the targeted treatment area, it is common for the tools used during said therapy to become coated with the lubricant during usage, thereby rendering them slippery. One drawback to known prior art soft tissue tool designs is that they lack adequate means for gripping or holding the tools in the presence of a lubricant, thereby making the tools more difficult to use for the therapist.

Another drawback to known soft tissue treatment tools is that they are not adequately configured to permit treatment of all potential soft tissue treatment areas, and are not sized to permit their optimal use on larger individuals.

It is desirable therefore to provide tools for the treatment of soft tissue having improved gripping means over the known prior art devices, and to provide tools that permit their optimal usage on larger individuals and on all potential soft tissue treatment areas of the body.

### BRIEF DESCRIPTION OF THE DRAWING(S)

FIG. 1 shows a perspective front view of one embodiment of a tool for treatment of soft tissue;

FIG. 2 shows a perspective front view of another embodiment of a tool for treatment of soft tissue;

FIG. 3 is a schematic diagram of another embodiment of a tool for treatment of soft tissue;

FIG. 4 is a schematic diagram of another embodiment of a tool for treatment of soft tissue;

FIG. 5 is a schematic diagram of the embodiment of FIG. 2;

FIG. 6 is a schematic diagram of another embodiment of a tool for treatment of soft tissue;

FIG. 7 is a schematic diagram of the embodiment of FIG. 1;

FIG. 8 is a schematic diagram of another embodiment of a tool for treatment of soft tissue;

FIG. 9 is a schematic diagram of another embodiment of a tool for treatment of soft tissue;

FIG. 10 is a schematic diagram of another embodiment of a tool for treatment of soft tissue; and

FIG. 11 is a schematic diagram of another embodiment of a tool for treatment of soft tissue.

### DETAILED DESCRIPTION OF THE PREFERRED EMBODIMENTS

When a soft tissue injury occurs in the body, scar tissue or fibrous adhesions may form on or around muscles, ligaments, tendons, or combinations thereof. Built-up scar tissue may, for example, reduce joint mobility and flexibility. Treatment of damaged soft tissue areas by therapists with the bare hands may be difficult, and can result in injuries to the therapist. Therefore, rigid tools for the treatment of soft tissue injuries, as noted above, were developed.

In order to perform soft tissue massage utilizing tools, it is known in the art to first topically treat the affected soft tissue area with a lubricant such as a liniment or cocoa butter. One drawback to known soft tissue treatment tools is that they are difficult to grip once they become coated with the lubricant. Known soft tissue treatment tools provide inadequate gripping means.

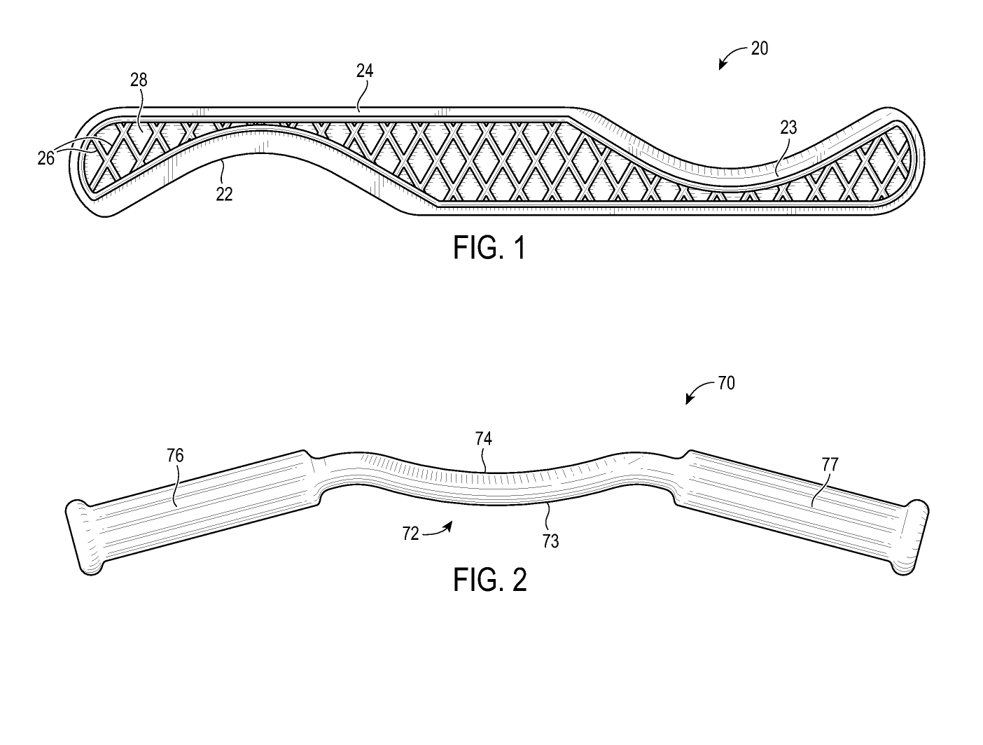

Referring now the FIG. 1, one embodiment of a tool 20 for treatment of soft tissue is shown. In this embodiment, tool 20 includes a pair of contoured portions 22, 23 which are used as skin-contacting portions in order to provide treatment to a targeted area. Essentially, the contoured portions 22, 23 of tool 20 are contoured to match the general shape of the joint or area being treated, thereby permitting increased contact with the treatment area. The tool 20 also includes an outer edge portion 24, which may include a flat edge portion and a beveled edge portion. The beveled edge portion may include, for example, a pair of separate beveled surfaces, with each beveled surface having a unique angle vis-à-vis the adjacent face of the tool 20. These features are known from the prior art references which have been incorporated by reference above.

In order to improve its gripping surface, tool 20 includes a plurality of raised cross-hatch members 26 which collectively form a plurality of cross-hatch cells 28. The inclusion of the cross-hatch cells 28 constitutes an improvement over the known prior art. Tools 10, 20, 30, 40, 50, and 60 are provided with this cross-hatching feature. In other embodiments, the cross-hatch members could be arranged in any possible pattern to form cross-hatch cells of various shapes, for example circular, rectangular, triangular, etc. The textured surface of the tool 20 provided by the cross-hatch cells 28 reduces the likelihood that a user of the tool 20 will lose grip on it due to the presence of a lubricant. This improves the effectiveness of a treatment session employing the tool 20 by increasing the therapist's control over the tool 20, while reducing the risk of injury to either the therapist or the patient due to slippage of the tool 20.

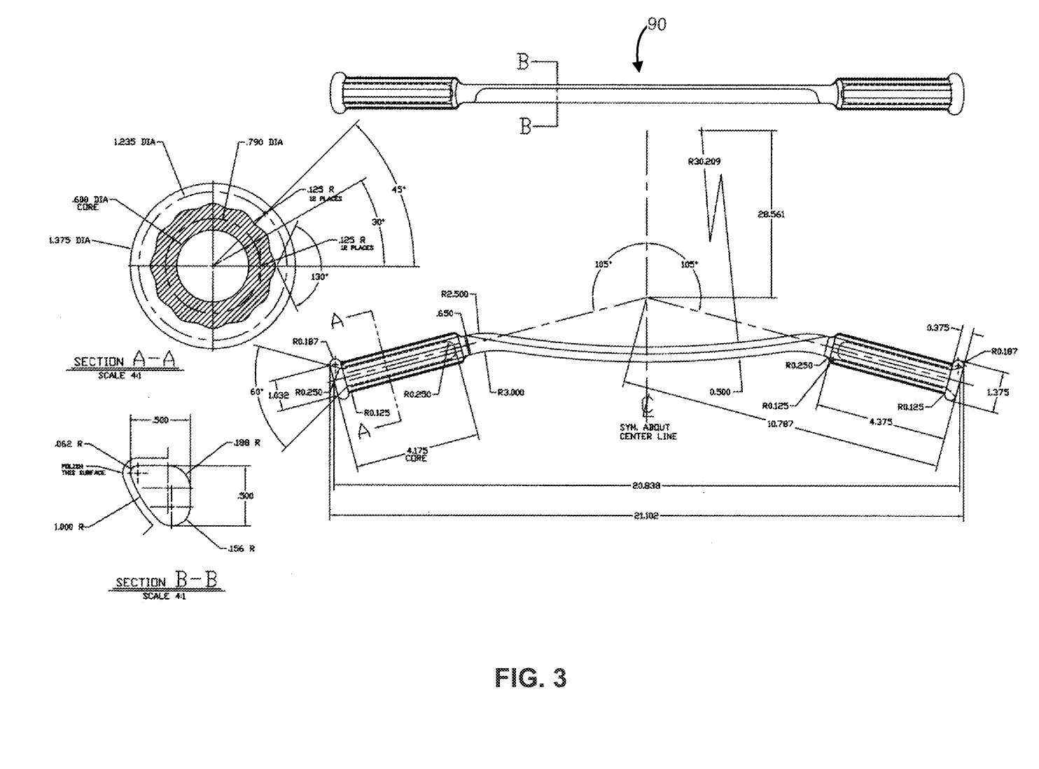

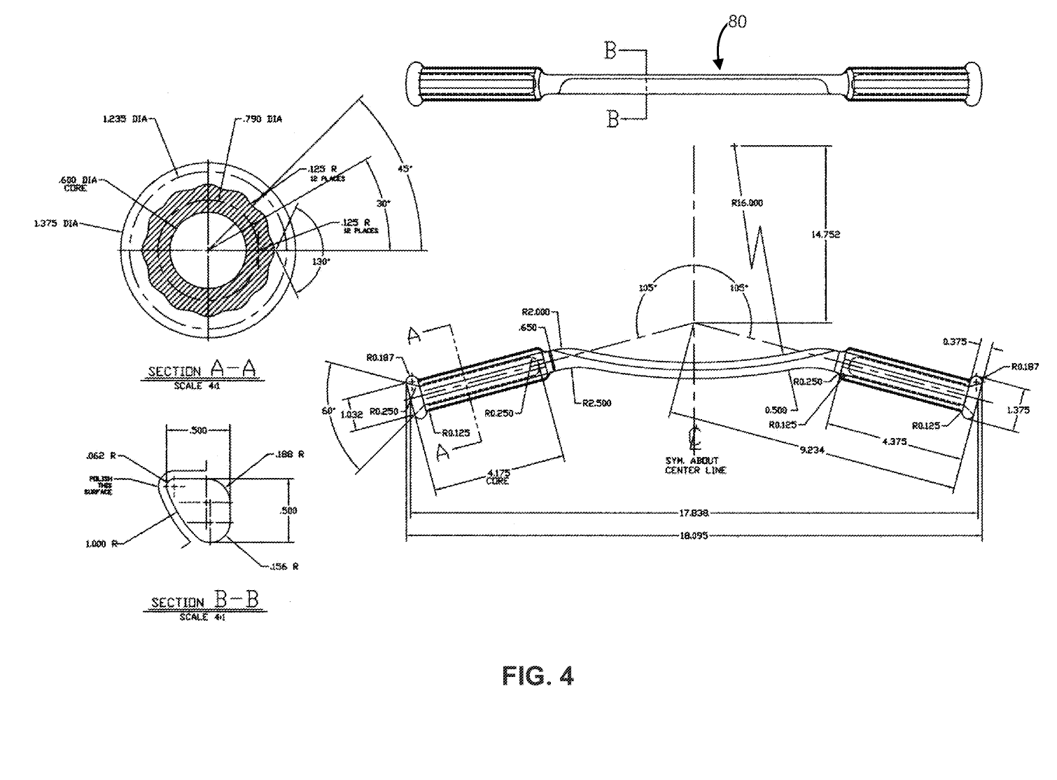

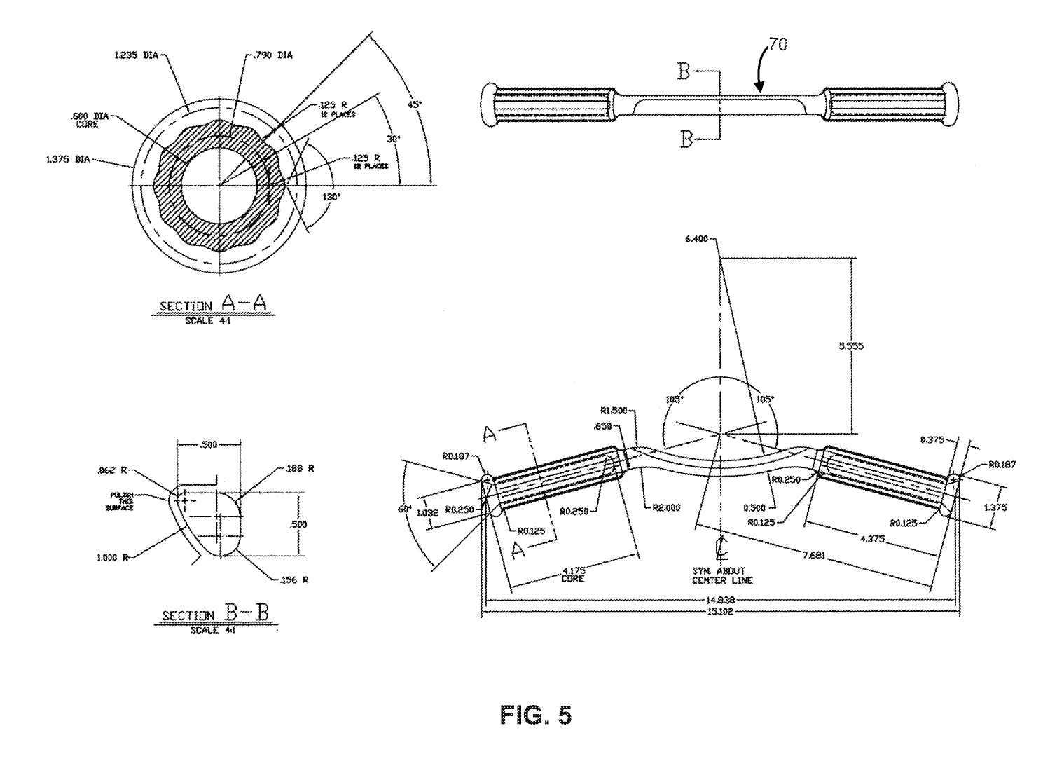

Referring now to FIG. 2, another embodiment of a tool 70 for treatment of soft tissue is shown. Tool 70 is provided with a skin-contacting section 72 which includes a convex treatment portion 73 and a concave treatment portion 74. The treatment portions 73, 74 are used for treatment of targeted treatment areas, as determined by the therapist. In this embodiment, tool 70 is provided with a pair of handles 76, 77, which are designed to improve grip and handling of the tool 70 by a user and which constitute an improvement over the known prior art. Tools 70, 80, 90 are provided with handles. In the embodiment shown in FIG. 2, the handles 76, 77 are of solid-core construction. In alternate embodiments, the handles could be provided with a partial- or completely-hollow core (see FIGS. 3-5). The hollow core of the handles could extend all the way through the end of the handle, or could terminate short of the respective end of the handle. The hollow-core handles have the benefits of reducing the weight of the tool 70 and of making vibration of the tool 70 more detectable as a soft-tissue treatment area is being treated. This latter benefit increases the ability of the therapist to determine the condition of the treatment area while using the tool 70, for example by making the presence of scar tissue in an area more easily recognizable.

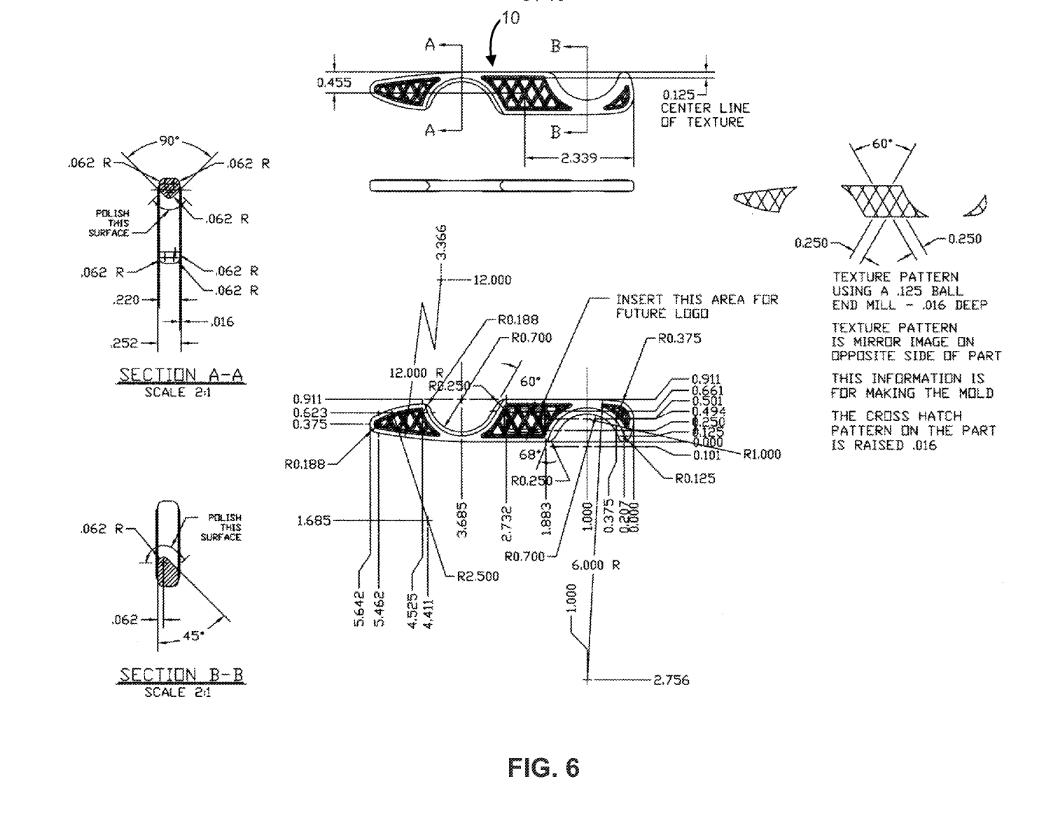

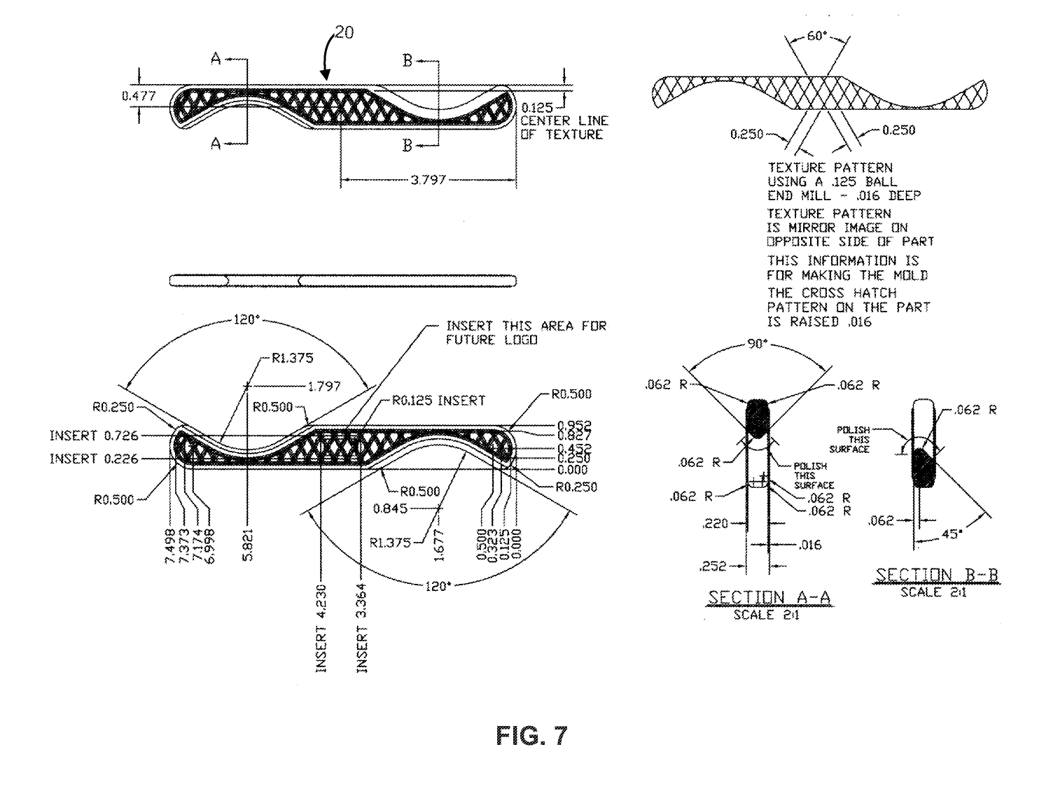

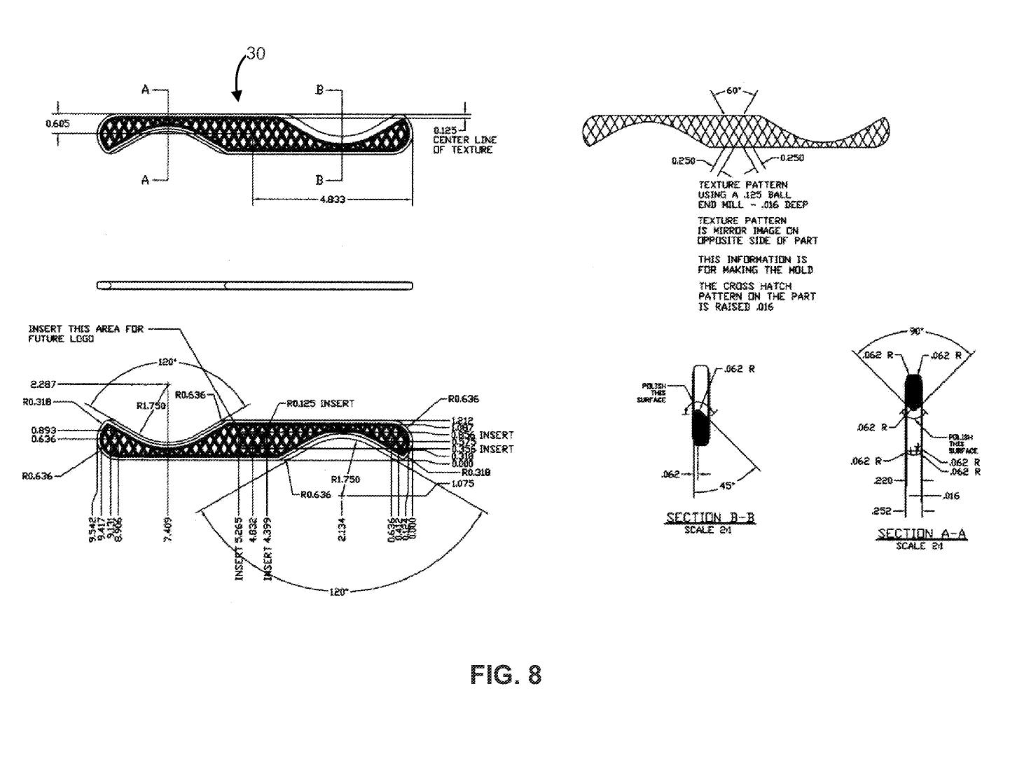

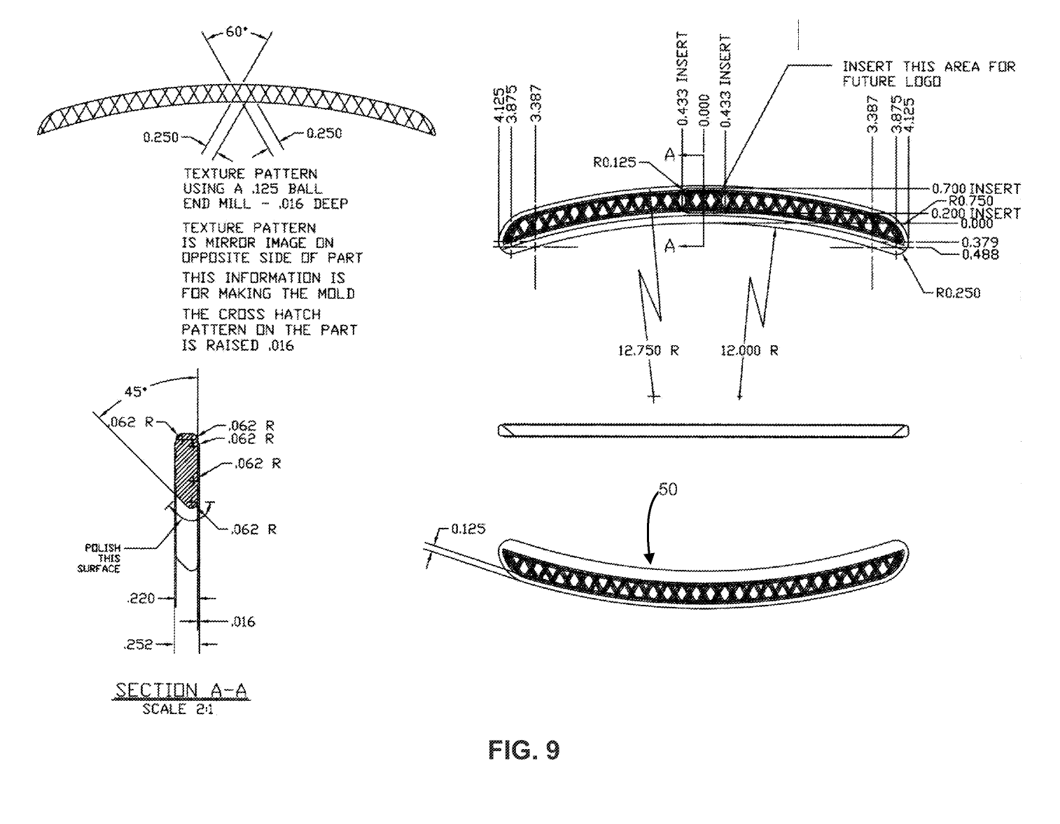

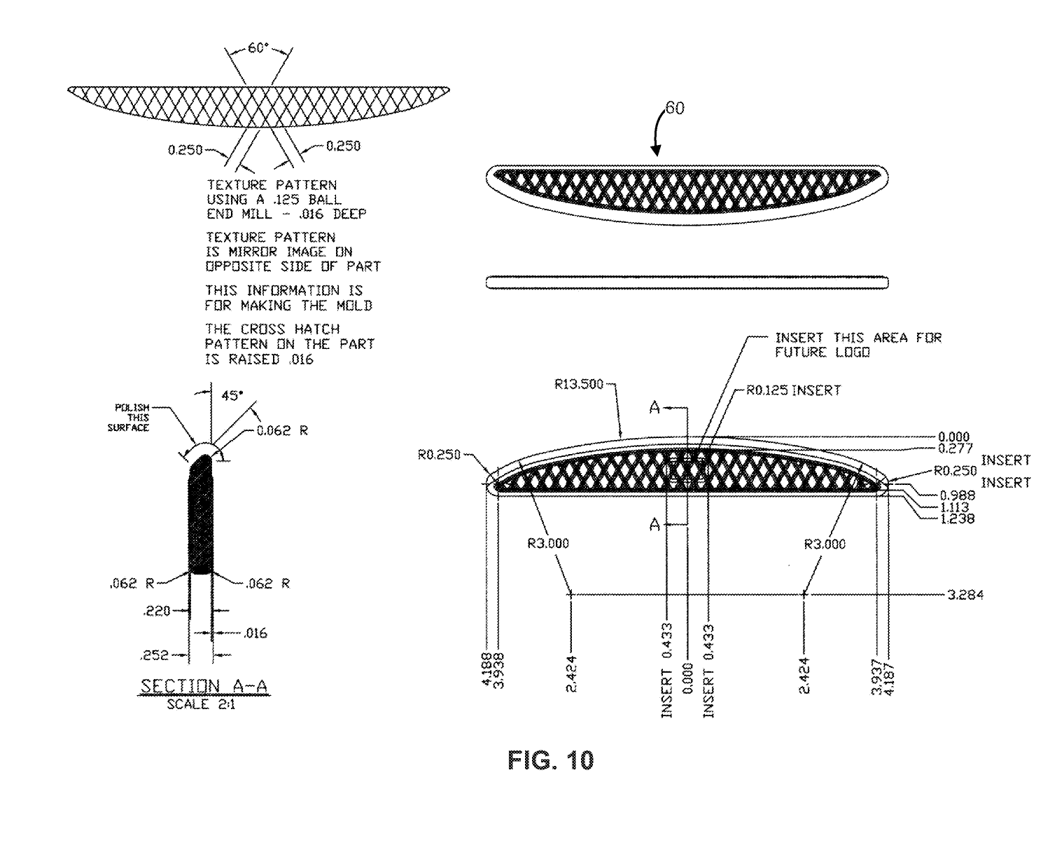

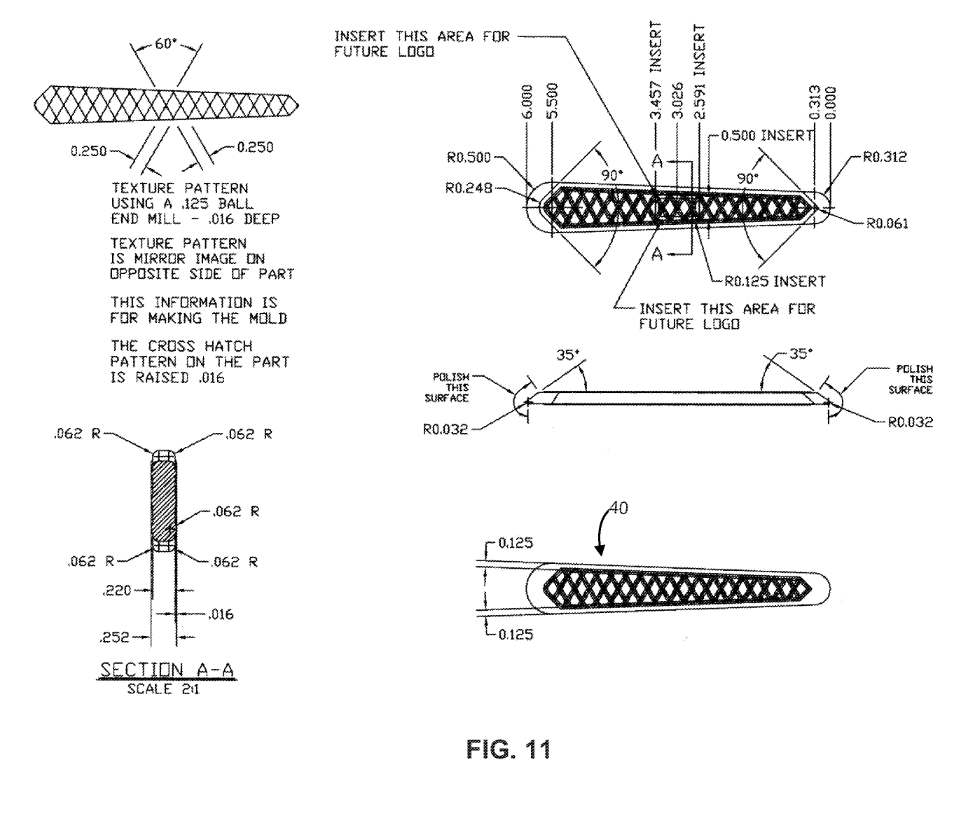

It is noted that the tools of the present invention may be used on any part of the body in which a soft tissue injury has occurred and scar tissue has been built up as a result of the healing process. In the embodiments shown in FIGS. 1-11, the tools are made from stainless steel, though other materials may be suitable, for example aluminum. The tools shown in FIGS. 1-11 represent just one example of a set of tools according to the present invention for use in soft tissue therapy. It should be understood that the tools illustrated herein do not comprise an exhaustive list of tools that may be required for treatment of all potential soft tissue treatment areas, but are merely illustrative of the different shapes and sizes of tools available as a set to treat some parts of the body. In addition, it is noted that each of the tools shown herein may be used on different parts of the body as needed.

For example, tool 70 is fundamentally a smaller version of tool 80, tool 90 is fundamentally a larger version of tool 80, and tool 30 is fundamentally a larger version of tool 20. These tools are designed for use on smaller or larger individuals, as appropriate, and their inclusion in a set of tools increases a therapist's flexibility in appropriately choosing a tool for a particular soft-tissue treatment session. Tool 70, for example, was deliberately designed to be a smaller version of tool 80 so that therapists could, for example, more easily maneuver the tool 70 in the vicinity of a patient's inner thigh or buttocks while reducing the risk of their hands coming in contact with the patient's groin area.

It will be appreciated that the foregoing is presented by way of illustration only, and not by way of any limitation, and that various alternatives and modifications may be made to the illustrated embodiments without departing from the spirit and scope of the invention.

1. (canceled)

2. (canceled)

3. A tool for the treatment of soft tissue, the tool comprising:
a first face;
a second face located opposite the first face;
at least one contoured portion designed to be placed in contact with a treatment area of a patient, the at least one contoured portion being shaped so as to match a general shape of the treatment area; and
an outer edge portion comprising at least one of a beveled portion and a flat edge portion;
wherein at least one of the first face and the second face comprises a plurality of raised cross-hatch members.

4. The tool of claim 3, wherein the plurality of raised cross-hatch members collectively form a plurality of cross-hatch cells.

5. The tool of claim 4, wherein at least one of the plurality of cross-hatch cells has a quadrilateral shape.

6. The tool of claim 3, wherein the tool is comprised of stainless steel.

7. A tool for the treatment of soft tissue, the tool comprising:
at least one skin-contacting section, the at least one skin-contacting section comprising a convex treatment portion and a concave treatment portion, each of the convex treatment portion and the concave treatment portion being shaped so as to match a general shape of a treatment area of a patient;
a first handle connected to and located on a first side of the skin-contacting section; and
a second handle connected to and located on a second side of the skin-contacting section.

8. The tool of claim 7, wherein the first and second handles each have a core that is at least partially hollow.

9. The tool of claim 7, wherein the tool is comprised of stainless steel.

10. The tool of claim 3, wherein both of the first face and the second face comprise a plurality of raised cross-hatch members.

11. The tool of claim 3, wherein the outer edge portion comprises a beveled portion comprising a pair of separate beveled surfaces, wherein each beveled surface of the pair of separate beveled surfaces has a unique angle vis-à-vis the respective one of the first face and the second face to which it is located adjacent.

12. The tool of claim 7, wherein the tool is symmetrical about a center line.

13. The tool of claim 8, wherein the at least partially hollow core of at least one of the first and second handles extends through a lateral end of the respective handle.

14. A tool for the treatment of a patient by a therapist in the presence of a lubricant, the tool comprising:
at least one skin-contacting portion designed to be placed in contact with a treatment area located on the patient, the at least one skin-contacting portion being shaped so as to match a general shape of the treatment area; and
means for improving the therapist's ability to grip the tool in the presence of the lubricant while the patient's soft tissue is being treated.

15. The tool of claim 14, wherein the means for improving the therapist's ability to grip the tool comprises a plurality of raised cross-hatch members.

16. The tool of claim 14, wherein the means for improving the therapist's ability to grip the tool comprises a pair of handles.

17. The tool of claim 16, wherein each handle of the pair of handles has a core that is at least partially hollow.

18. The tool of claim 17, wherein the at least partially hollow core of at least one handle of the pair of handles extends through a lateral end of the respective handle.

19. The tool of claim 16, wherein the tool is symmetrical about a center line.
